(19) United States
(12) Patent Application Publication
(10) Pub. No.: US 2016/0267072 A1
(43) Pub. Date: Sep. 15, 2016

(54) CONTEXT SENSITIVE PHRASE IDENTIFICATION

(71) Applicant: Microsoft Technology Licensing, LLC, Redmond, WA (US)

(72) Inventors: Thomas Kappler, Uster (CH); Bernd Kiefer, Zurich (CH); Peter Johan Stengård, Zumikon (CH)

(21) Appl. No.: 14/836,361

(22) Filed: Aug. 26, 2015

Related U.S. Application Data
(60) Provisional application No. 62/131,932, filed on Mar. 12, 2015.

(51) Int. Cl. G06F 17/27; G06F 17/24

(52) U.S. Cl. CPC G06F 17/2715; G06F 17/277; G06F 17/24

(57) ABSTRACT

A computing device for processing textual information from at least one source of textual information is provided. The computing device includes a processor that is a functional component of the computing device and is configured to execute instructions to process the textual information. A listener component is configured to receive the textual information from the at least one source. A context analyzer is coupled to the listener component and is configured to generate context information relative to the textual information. A content analyzer is coupled to the listener component and is configured to identify a set of n-grams from the textual information and to provide filtered content by removing at least some n-grams using a probabilistic data structure that determines if a given element is a member of a set. An indexing component is configured to index the filtered content.

### CROSS-REFERENCE TO RELATED APPLICATION

The present application is based on and claims the benefit of U.S. provisional patent application Ser. No. 62/131,932, filed Mar. 12, 2015, the content of which is hereby incorporated by reference in its entirety.

### BACKGROUND

People all over the world continuously contribute content to various sites, such as social media sites, blogs, news sources, etc. However, it is difficult to identify certain aspects of the conversations or content for specific contexts.

The discussion above is merely provided for general background information and is not intended to be used as an aid in determining the scope of the claimed subject matter.

### SUMMARY

A computing device for processing textual information from at least one source of textual information is provided. The computing device includes a processor that is a functional component of the computing device and is configured to execute instructions to process the textual information. A listener component is configured to receive the textual information from the at least one source. A context analyzer is coupled to the listener component and is configured to generate context information relative to the textual information. A content analyzer is coupled to the listener component and is configured to identify a set of n-grams from the textual information and to provide filtered content by removing at least some n-grams using a probabilistic data structure that determines if a given element is a member of a set. An indexing component is configured to index the filtered content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of a phrase identification architecture in accordance with one embodiment.

FIG. 2 is a flow diagram of a method of analyzing and indexing content from various public facing sites in accordance with one embodiment.

FIG. 3 is a flow diagram of a method for searching an index of content from various public facing sites in accordance with one embodiment.

FIG. 4 is a block diagram showing the architecture illustrated in FIG. 1, deployed in a cloud computing architecture.

FIG. 5-7 show various examples of mobile devices that can be used in the architectures discussed in the previous figures.

FIG. 8 is a block diagram of one example of a computing environment that can be used in various parts of the architectures set out in the previous figures.

### DETAILED DESCRIPTION

It is currently possible to extract key phrases from text based on trained language models. However, such techniques are computationally intensive and are not suitable for processing massive amounts of streaming social media content. Further, social media content is increasingly becoming some of the most relevant content for identifying events or topics very quickly and dynamically tracking such content.

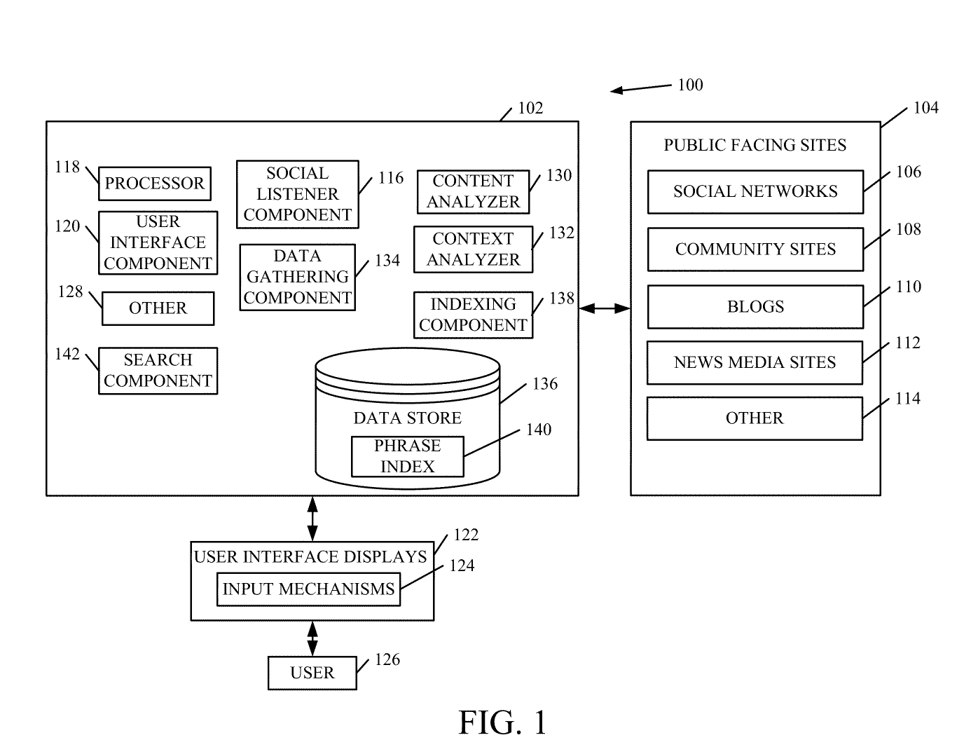

FIG. 1 is a block diagram of one example of a phrase identification architecture 100. Architecture 100 illustratively includes a computing system 102 and a set of public facing sites or sources 104. By way of example, public facing sites 104 provide sources of content that are analyzed and indexed by computing system 102. Public facing sites 104 can include, but is not limited to, social networks 106, community sites 108, blogs 110, news media sites 112, and any of a wide variety of other public facing sites 114. Social networks 106 include, without limitation, such networks as facebook.com, instagram.com, Google+, twitter.com, and other sites or networks now know or later developed that allow and facilitate interactions between massive numbers of users. Community sites 108 include, without limitation, individual electronic bulletin boards or other forms of message sites that are formed around specific topics of interest for a community of users. Moreover, community sites 108 may also include sites of interest to a geographical community as well, for example, a city. Blogs 110 can include, without limitation, any sites that are regularly updated by an individual or relatively small group of individuals and written in an informal or conversational style. News media sites 112 include, without limitation, any electronics sites of news media or outlets, whether international, national, regional, or local. Other public facing sites 114 include, without limitation, any publicly available sources of electronic information. In one embodiment, such sites include any regularly updated source of electronic information that is provided in a relatively unstructured format.

Computing system 102 illustratively includes a social listener component 116 that monitors information generated by public facing sites 104. Computing system 102 also includes a processor 118 and a user interface component 120 that generates user interface displays 122 with user input mechanisms 124. Processor 118, in one embodiment, is a functional component of computing system 102 and is configured to execute instructions to process textual information. A user 126 illustratively interacts with, or actuates, the user input mechanisms 124 in order to control and manipulate computing system 102. Computing system 102 can include other items 128 as well.

Computing system 102 provides a framework for identifying key aspects of conversations (e.g., topics) for specific contexts (including an entire context) over the content received from public facing sites 104. In the present example, key aspects of a conversation include a set (one or more) of keywords or phrases occurring within the context (e.g., “CEO Retires”, “Measles Outbreak”, “Battery Catches Fire”). A context can be, but is not limited to, one or more combinations of textual keywords, social media sources, geographic regions, time periods, authors, etc. The framework provided by computing system 102 is able to process very large amounts of streaming social media or other content from public facing sites 104, and allow users (e.g., user 126) to subsequently identify key conversational phrases over a dynamically defined context.

As mentioned above, information generated from sites 104 is provided to social listener component 116. A content analyzer 130 is configured to analyze the content provided from public facing sites 104 and a context analyzer 132 is configured to identify a context of that content. This information can be provided to a data gathering component 134 and indexed in a data store 136 using an indexing component 138. Data store 136 illustratively stores a phrase index 140, which indexes phrases identified from the content provided from public facing sites 104.

Using phrase index 140, a search component 142 can execute a search based on a query received from user 126 to identify key aspects of conversations for a user-defined context. For example, user 126 may desire to find key aspects of conversations from public facing sites 104 from a particular social media source context and/or a geographic region context, for a particular set of keywords.

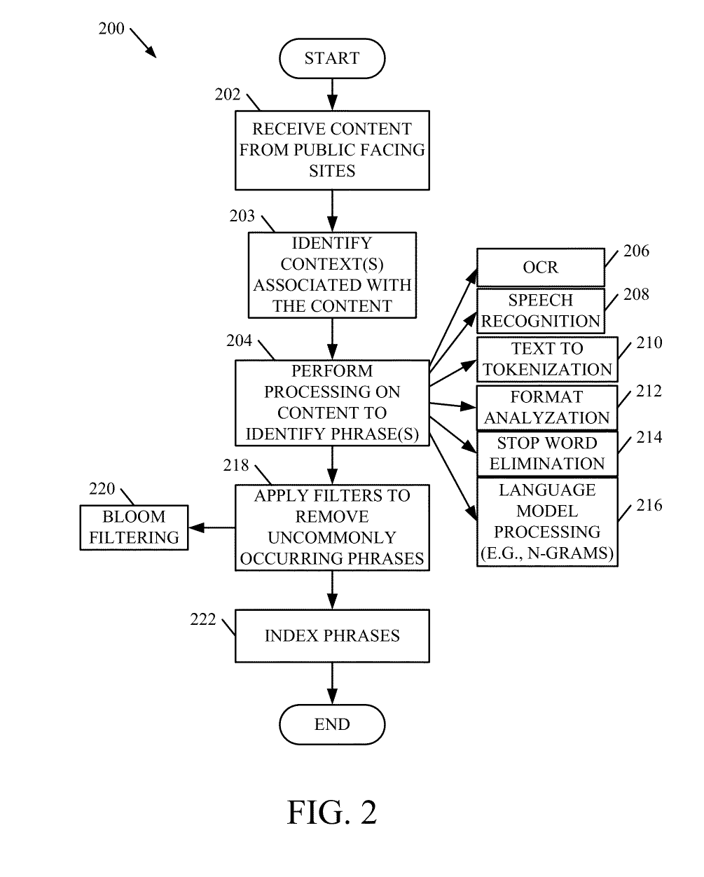

FIG. 2 is a flow diagram of a method 200 of analyzing and indexing content from various public facing sites in accordance with one embodiment. For the sake of illustration, but not by limitation, method 200 will be described in the context of architecture 100. At block 202, content is received from public facing sites 104 by social listener component 116. For example, a document can be received from a social network 106 or a news media site 112. In one example, the received content can comprise unstructured textual content. In another example, the received content can comprise non-textual content, such as images, audio, and/or video content.

At block 203, one or more contexts associated with the received content is identified. For example, block 203 can be performed by context analyzer 132. Examples of contexts include, but is not limited to, combinations of textual keywords in the content, a particular social media source from which the content is received, a geographic region from which the content originated, an author of the content, and a time period in which the content was authored.

At block 204, processing is performed on the content received at block 202 to identify phrases. For example, for non-textual content, optical character recognition 206 and/or speech recognition 208 can be performed on the content to obtain a textual representation of the content. Further, the processing can include text tokenization 210, format analyzation 212, and/or stop word elimination 214 which removes stop words from the content. Text tokenization 210 may, in one embodiment, employ breaks or white space to break the text stream into words or other meaningful blocks. Format analyzation 212, can inspect formats parameters of the text in order to identify text of higher importance. Such format parameters can includes such features as capitalization, whether the text is bold and/or italicized, whether the text is highlighted or has a different color, etc. Removal of stop words 214 removes words from a predefined set of stop words from the text. Stop words are words that are very common and of relatively little meaningful value. Examples of such stop words include, “the, is, at, which, and, or” etc. In addition to removing stop words, block 214 may also remove text that has the format of a URL. The list of stop words is predefined, and may vary based on the specific language being used. At block 216, language model processing is performed to generate n-grams to identify phrases from words in a sequence in the content. In accordance with various embodiments described herein, such n-grams may include unigrams, bi-grams, and tri-grams. However, larger n-grams may also be employed.

At block 218, one or more filters are applied to the identified phrases to remove uncommonly occurring phrases. In one embodiment, such filtering employs a probabilistic data structure to efficiently determine if an element is a member of a set, as indicated at block 220. One such filter is a Bloom filter where, false positive matches are possible, but false negatives are not. Therefore, a Bloom filter can have a 100 percent recall rate. In other words, a query returns either “Possibly In Set” or “Definitely Not In Set.” Further, such filter is highly efficient at handling large volumes of source data. The Bloom filter may be implemented as one or more layers of Bloom filters. For example, a first layer Bloom filter may determine whether the N-grams generated at block 204 have existed previously. Then, if the first layer of the Bloom filter returns True, the n-grams may be applied to the second layer of the Bloom filter. Certainly, embodiments described herein can be practiced using additional layers. However, the filter layer structure provides an advantage in that a significant percentage of relatively uncommon n-grams will not pass the first filter layer, and thus not require further processing. In one embodiment, the Bloom filter is occasionally reset. This may occur when the Bloom filter is determined to be filled to a certain level, such as half.

In the example of FIG. 2, the filtering applied at block 218 helps identify key conversational phrases by eliminating uncommonly occurring phrases. In one example, the phrases identified at block 204 are scored based on occurrence statistics, with the phrases having lower scores being eliminated prior to phrase indexing. In one example, computing system 102 may also applies “Phrase Folding” to identify and eliminate lower scoring n-grams into higher scoring, matching, n-grams.

At block 222, the phrases are indexed in data store 136. For example, phrase index 140 indexes each of the phrases from step 218 relative to the identified contexts identified at step 203.

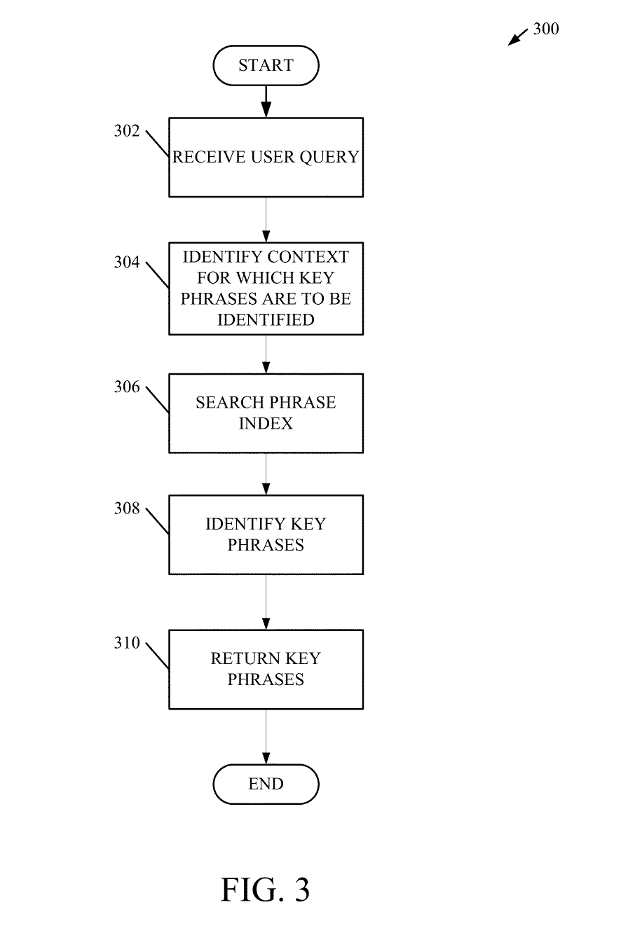

FIG. 3 is a flow diagram of one example of a method 300 for searching an index of content from various public facing sites. For the sake of illustration, but not by limitation, method 300 will be described in the context of architecture 100. At block 302, a user query is received. For example, user 126 can provide a search query through user input mechanisms 124. At block 304, a context is identified for which key phrases are to be identified. For example, the context can be explicitly defined in the user query received at block 302, or can be inferred from the user query.

At block 306, phrase index 140 is searched based on the identified context. In one example, system 102 performs aggregations to find key phrases which occur at different rates for the defined context of interest, versus the entire context as a whole. The key phrases are identified at block 308 and returned as results to the user at block 310.

Embodiments described herein generally provide effective processing of massive amounts of streams of textual information, such as social media content. Moreover, the indexing provided allows users to define various contexts for searching the indexed text to allow efficient interaction with dynamically changing content.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

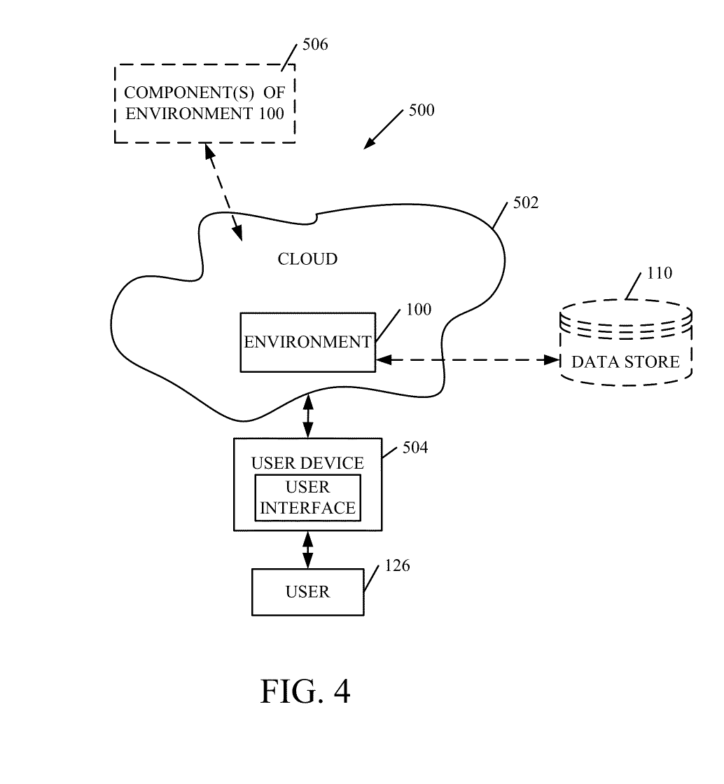

FIG. 4 is a block diagram of a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that some or all components of environment 100 are located in cloud 502 (which can be public, private, or a combination where portions are public while others are private). Therefore, user 126 uses a user device 504 to access those components through cloud 502.

FIG. 4 also depicts another embodiment of a cloud architecture. FIG. 4 shows that it is also contemplated that some elements of computing system 100 are disposed in cloud 502 while others are not. By way of example, data store 110 can be disposed outside of cloud 502, and accessed through cloud 502. In another embodiment, some components of architecture 100 (represented by block 506) also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

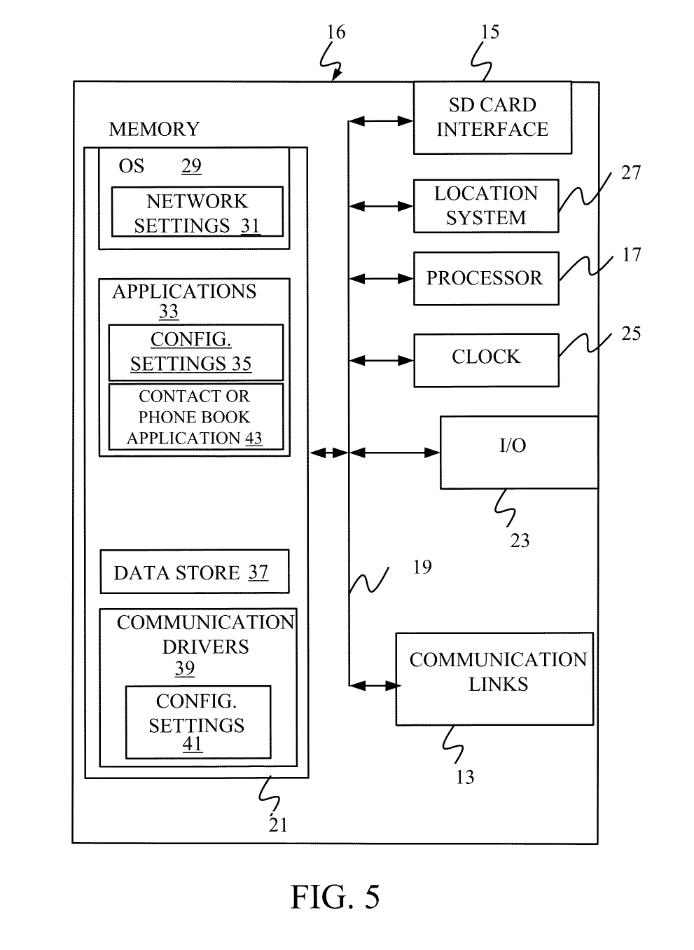

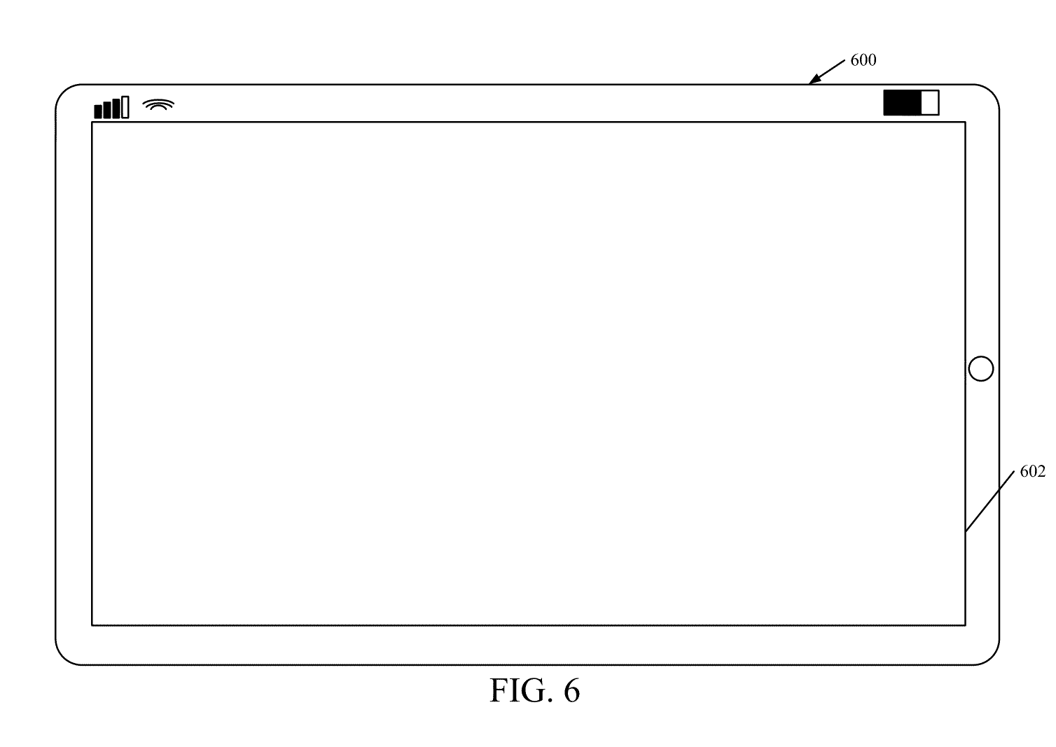

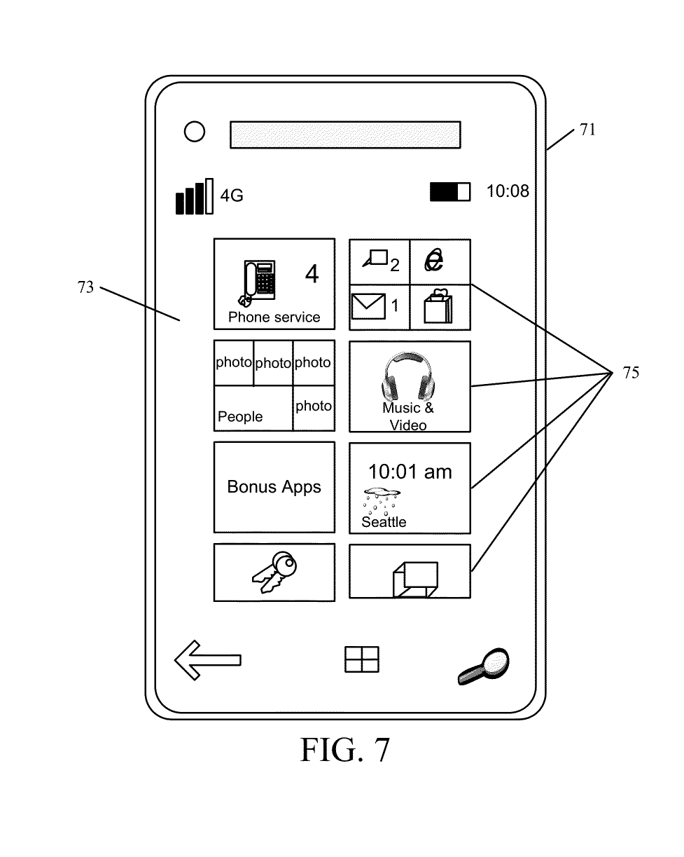

FIG. 5 is a simplified block diagram of one illustrative embodiment of a handheld or mobile computing device that can be used as a user's or client's hand held device 16, in which the present system (or parts of it) can be deployed. FIGS. 6-7 are examples of handheld or mobile devices.

FIG. 5 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Items in data store 110, for example, can reside in memory 21. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display displayed on the display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used, as well. Device 16 can be a feature phone, smart phone or mobile phone. The phone includes a set of keypads for dialing phone numbers, a display capable of displaying images including application images, icons, web pages, photographs, and video, and control buttons for selecting items shown on the display. The phone includes an antenna for receiving cellular phone signals such as General Packet Radio Service (GPRS) and 1×rtt, and Short Message Service (SMS) signals. In some embodiments, phone also includes a Secure Digital (SD) card slot that accepts a SD card.

The mobile device can be personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. Although not shown, The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device also includes a SD card slot that accepts a SD card.

FIG. 7 shows that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

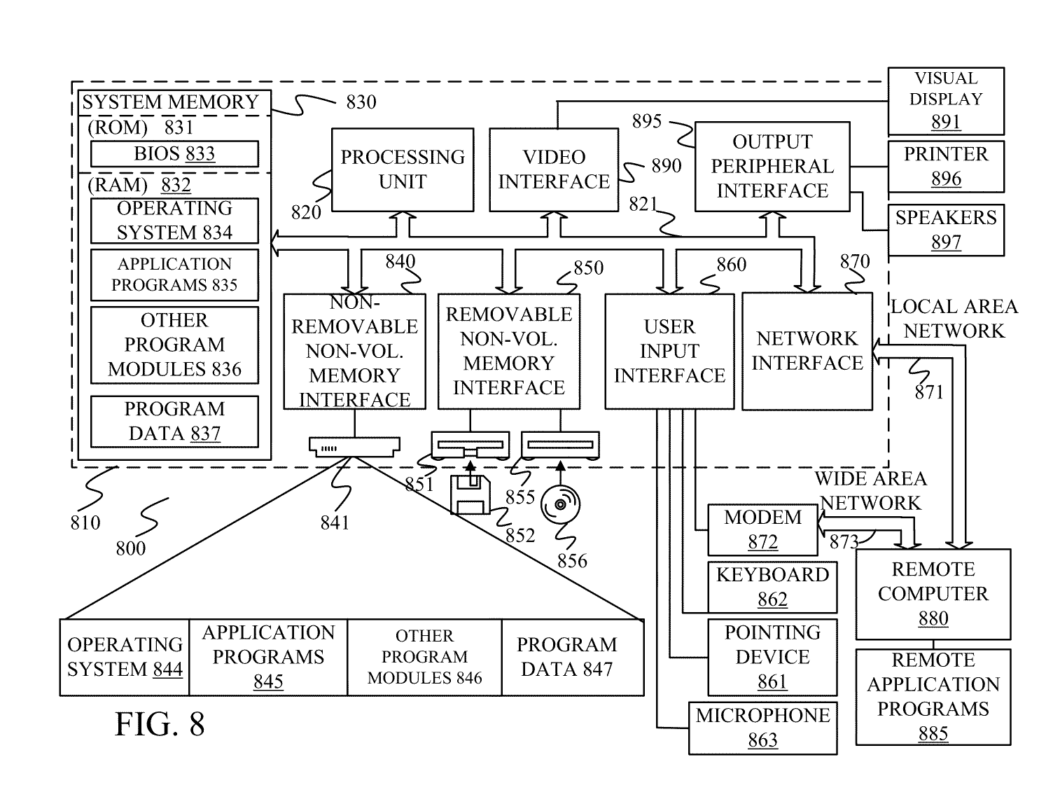

FIG. 8 is one embodiment of a computing environment in which architecture 100, or parts of it, (for example) can be deployed. With reference to FIG. 8, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing device for processing textual information from at least one source of textual information is provided. The computing device includes a processor that is a functional component of the computing device and is configured to execute instructions to process the textual information. A listener component is configured to receive the textual information from the at least one source. A context analyzer is coupled to the listener component and is configured to generate context information relative to the textual information. A content analyzer is coupled to the listener component and is configured to identify a set of n-grams from the textual information and to provide filtered content by removing at least some n-grams using a probabilistic data structure that determines if a given element is a member of a set. An indexing component is configured to index the filtered content.

Example 2 is the computing device of any or all previous examples wherein the listener component is a social listener component and wherein the at least one source of textual information includes a social network.

Example 3 is the computing device of any or all previous examples wherein the listener component is configured to receive a stream of textual information from the at least one source of textual information.

Example 4 is the computing device of any or all previous examples wherein the probabilistic data structure includes a Bloom filter.

Example 5 is the computing device of any or all previous examples wherein the Bloom filter includes a plurality of layers with a first layer being an input to a second layer.

Example 6 is the computing device of any or all previous examples wherein the computing device is configured to reset the Bloom filter.

Example 7 is the computing device of any or all previous examples wherein the computing device is configured to reset the Bloom filter when the Bloom filter is filled to a selected threshold.

Example 8 is the computing device of any or all previous examples wherein the content analyzer is configured to apply text tokenization to the textual information to tokenize the textual information.

Example 9 is the computing device of any or all previous examples wherein the content analyzer is further configured to analyze format of the textual information.

Example 10 is the computing device of any or all previous examples wherein the content analyzer is further configured to remove stop words from the textual information.

Example 11 is the computing device of any or all previous examples wherein the content analyzer is further configured to remove uniform resource locators in the textual information.

Example 12 is the computing device of any or all previous examples wherein the content analyzer is configured to fold at least some n-grams into matching n-grams having higher occurrence scores.

Example 13 is the computing device of any or all previous examples and further comprising a user interface component configured to receive an input query specifying a context and provide query results based on the specified context and the indexed filtered content.

Example 14 is the computing device of any or all previous examples wherein the index of filtered content is stored in a data store of the computing device.

Example 15 is a method of processing social media content. The method includes receiving social media content from at least one social media network. The social media content is conditioned n-grams are identified in the conditioned social media content. At least some n-grams are removed using a probabilistic data structure that determines if a given element is a member of a set, to generate filtered n-grams. The filtered n-grams are indexed.

Example 16 is the method of any or all previous examples wherein the probabilistic data structure is a Bloom filter.

Example 17 is the method of any or all previous examples wherein the Bloom filter is a multi-layered Bloom filter.

Example 18 is the method of any or all previous examples and further comprising receiving a query and context information and providing query results based on the indexed, filtered n-grams and the context information.

Example 19 is the method of any or all previous examples wherein conditioning the social media content includes applying tokenization, analyzing format, and removing stop words.

Example 20 is a computing device for providing interaction with context sensitive phrases. The computing device includes a processor that is a functional component of the computing device and is configured to execute instructions to process social media textual information. A data store contains an index of filtered social media textual information. A user interface component is configured to receive a context of interest, and provide a result using the index of filtered social media textual information.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device for processing textual information from at least one source of textual information, the computing device comprising:
a processor that is a functional component of the computing device and is configured to execute instructions to process the textual information;
a listener component configured to receive the textual information from the at least one source;
a context analyzer coupled to the listener component and configured to generate context information relative to the textual information.
a content analyzer coupled to the social listener component and configured to identify a set of n-grams from the textual information and to provide filtered content by removing at least some n-grams using a probabilistic data structure that determines if a given element is a member of a set; and
an indexing component configured to index the filtered content.

2. The computing device of claim 1, wherein the listener component is a social listener component and wherein the at least one source of textual information includes a social network.

3. The computing device of claim 1, wherein the listener component is configured to receive a stream of textual information from the at least one source of textual information.

4. The computing device of claim 1, wherein the probabilistic data structure includes a Bloom filter.

5. The computing device of claim 4, wherein the Bloom filter includes a plurality of layers with a first layer being an input to a second layer.

6. The computing device of claim 4, wherein the computing device is configured to reset the Bloom filter.

7. The computing device of claim 6, wherein the computing device is configured to reset the Bloom filter when the Bloom filter is filled to a selected threshold.

8. The computing device of claim 1, wherein the content analyzer is configured to apply text tokenization to the textual information to tokenize the textual information.

9. The computing device of claim 8, wherein the content analyzer is further configured to analyze format of the textual information.

10. The computing device of claim 9, wherein the content analyzer is further configured to remove stop words from the textual information.

11. The computing device of claim 10, wherein the content analyzer is further configured to remove uniform resource locators in the textual information.

12. The computing device of claim 1, wherein the content analyzer is configured to fold at least some n-grams into matching n-grams having higher occurrence scores.

13. The computing device of claim 1, and further comprising a user interface component configured to receive an input query specifying a context and provide query results based on the specified context and the indexed filtered content.

14. The computing device of claim 1, wherein the index of filtered content is stored in a data store of the computing device.

15. A method of processing social media content, the method comprising:
receiving social media content from at least one social media network;
conditioning the social media content;
identifying n-grams in the conditioned social media content;
removing at least some n-grams using a probabilistic data structure that determines if a given element is a member of a set, to generate filtered n-grams; and
indexing the filtered n-grams.

16. The method of claim 15, wherein the probabilistic data structure is a Bloom filter.

17. The method of claim 16, wherein the Bloom filter is a multi-layered Bloom filter.

18. The method of claim 15, and further comprising receiving a query and context information and providing query results based on the indexed, filtered n-grams and the context information.

19. The method of claim 15, wherein conditioning the social media content includes applying tokenization, analyzing format, and removing stop words.

20. A computing device for providing interaction with context sensitive phrases, the computing device comprising:
a processor that is a functional component of the computing device and is configured to execute instructions to process social media textual information;
a data store containing an index of filtered social media textual information; and
a user interface component configured to receive a context of interest, and provide a result using the index of filtered social media textual information.
